(19) United States
(12) Patent Application Publication
(10) Pub. No.: US 2012/0326995 A1
(43) Pub. Date: Dec. 27, 2012

(54) VIRTUAL TOUCH PANEL SYSTEM AND INTERACTIVE MODE AUTO-SWITCHING METHOD

(75) Inventors: Wenbo Zhang, Beijing (CN); Lei Li, Beijing (CN)

(73) Assignee: RICOH COMPANY, LTD., Tokyo (JP)

(21) Appl. No.: 13/469,314

(22) Filed: May 11, 2012

(30) Foreign Application Priority Data
Jun. 24, 2011 (CN) 201110171845.3

(51) Int. Cl. G06F 3/041

(52) U.S. Cl. 345/173

(57) ABSTRACT

Disclosed are a virtual touch panel system and an interactive mode auto-switching method. The virtual touch panel system comprises a projector configured to project an image on a projection surface; a depth map camera configured to obtain depth information of an environment containing a touch operation area; a depth map processing unit configured to generate an initial depth map, and to determine the touch operation area based on the initial depth map; an object detecting unit configured to detect, from each of plural images continuously obtained by the depth map camera after the initial circumstance, a candidate blob of at least one object located within a predetermined distance from the determined touch operation area; and a tracking unit configured to insert each of the blobs into a corresponding point sequence according to a relationship of the geometric centers of the blobs detected in adjacent two of the obtained images.

### BACKGROUND OF THE INVENTION

1. Field of the Invention

The present invention relates to the field of human machine interaction (HMI) and the field of digital image processing, and more particularly relates to a virtual touch panel system and an interactive mode auto-switching method.

2. Description of the Related Art

Touch panel technologies have been widely utilized in a portable apparatus (for example, a smart-phone) or a personal computer (for example, a desktop personal computer) serving as a HMI apparatus. By using the touch panel, a user may more comfortably and conveniently operate the apparatus; at the same time, the touch panel may bring about a good user experience. The touch panel technologies are very successful when used in the portable apparatus. However, when used in a touch panel of a wide display unit, touch panel technologies still have some problems and chances of improvement.

U.S. Pat. No. 7,151,530 B2 titled as “System And Method For Determining An Input Selected By A User Through A Virtual Interface” discloses a system and a method for determining which key value in a set of key values is to be assigned as a current key value; as a result, an object intersecting a region in a virtual interface is provided. The virtual interface may enable selection of individual key values in the set. A position is determined by using a depth sensor that determines a depth of the position in relation to the location of the depth sensor. A set of previous key values that are pertinent to the current key value may also be identified. In addition, at least one of either a displacement characteristic of the object or a shape characteristic of the object is determined. A probability is determined that indicates the current key value is a particular one or more of the key values in the set.

U.S. Pat. No. 6,710,770 B2 titled as “Quasi-Three-Dimensional Method And Apparatus To Detect And Localize Interaction Of User-Object And Virtual Transfer Device” discloses a system used when a virtual device inputs or transfers information to a companion device, and includes two optical systems OS1 and OS2. In a structured-light embodiment, OS1 emits a fan beam plane of optical energy parallel to and above the virtual device. When a user object penetrates the beam plane of interest, OS2 registers the event. Triangulation methods can locate the virtual contact, and transfer user-intended information to the companion system. In a non-structured active light embodiment, OS2 is preferably a digital camera whose field of view defines the plane of interest, which is illuminated by an active source of optical energy. Preferably the active source, OS1, and OS2 operate synchronously to reduce effects of ambient light. A non-structured passive light embodiment is similar except the source of optical energy is ambient light. A subtraction technique preferably enhances the signal/noise ratio. The companion device may in fact house the present invention.

U.S. Pat. No. 7,619,618 B2 titled as “Identifying Contacts On Touch Surface” discloses an apparatus and a method for simultaneously tracking multiple finger and palm contacts as hands approach, touch, and slide across a proximity-sensing, multi-touch surface. Identification and classification of intuitive hand configurations and motions enables unprecedented integration of typing, resting, pointing, scrolling, 3D manipulation, and handwriting into a versatile, ergonomic computer input device.

US Patent Application Publication No. 2010/0073318 A1 titled as “Multi-Touch Surface Providing Detection And Tracking Of Multiple Touch Points” discloses a system and a method for touch sensitive surface provide detection and tracking of multiple touch points on the surface by using two independent arrays of orthogonal linear capacitive sensors.

According to the above mentioned conventional techniques, most of wide touch panels are based on an electromagnetic board (for example, an electrical whiteboard), an IR board (such as an interactive wide display unit), etc. As for the conventional technical proposals of the wide touch panels, there still are many problems. For example, generally speaking, these kinds of apparatuses are difficult to be carried, i.e., do not have portability because they usually have a large volume and a large weight caused by their hardware. Furthermore, in these kinds of apparatuses, the size of the touch panel is limited by the hardware, and cannot be freely adjusted according to actual needs. In addition, a special electromagnetic pen or an IR pen is necessary to carry out operations.

Furthermore, with regard to some virtual whiteboard projectors, a user needs to execute control to turn on or turn off a laser pen; this is very complicated. As a result, there is a problem that the laser pen is difficult to be controlled. In addition, in these kinds of virtual whiteboard projectors, once the laser pen is turned off, it is difficult to accurately move the laser spot to the next position. Therefore there exists a problem that the laser spot is difficult to be positioned. In some virtual whiteboard projectors, a finger mouse is used to replace the laser pen; however, a virtual whiteboard projector adopting the finger mouse cannot detect a touch-on event and a touch-off (also called “touch-up”) event.

### SUMMARY OF THE INVENTION

In order to solve the above described problems in the prior art, a virtual touch panel system and an interactive mode auto-switching method are proposed in embodiments of the present invention.

According to one aspect of the present invention, a method of auto-switching interactive modes in a virtual touch panel system is provided. The method comprises a step of projecting an image on a projection surface; a step of continuously obtaining plural images of an environment of the projection surface; a step of detecting, in each of the obtained images, a candidate blob of at least one object located within a predetermined distance from the projection surface; and a step of inserting each of the blobs into a corresponding point sequence according to a relationship in time region and space region, of the geometric centers of the blobs detected in adjacent two of the obtained images. The detecting step includes a step of seeking a depth value of a specific pixel point in the candidate blob of the object; a step of determining whether the depth value is less than a predetermined first distance threshold value, and determining, in a case where the depth value is less than the predetermined first distance threshold value, that the virtual touch panel system is working in a first operational mode; and a step of determining whether the depth value is greater than the predetermined first distance threshold value and less than a predetermined second distance threshold value, and determining, in a case where the depth value is greater than the predetermined first distance threshold value and less than the predetermined second distance threshold value, that the virtual touch panel system is working in a second operational mode. Based on the relationships between the depth value and the predetermined first and second distance threshold values, the virtual touch panel system carries out automatic switching between the first operational mode and the second operational mode.

Furthermore, in the method, the first operational mode is a touch mode, and in the touch mode, a user performs touch operations on a virtual touch panel; and the second operational mode is a hand gesture mode, and in the hand gesture mode, the user does not use his hand to touch the virtual touch panel, whereas the user performs hand gesture operations within a certain distance from the virtual touch panel.

Furthermore, in the method, the predetermined first distance threshold value is 1 cm.

Furthermore, in the method, the predetermined second distance threshold value is 20 cm.

Furthermore, in the method, the specific pixel point in the candidate blob of the object is a pixel point whose depth value is maximum in the candidate blob.

Furthermore, in the method, the depth value of the specific pixel point in the candidate blob of the object is a depth value of a pixel point, greater than those of other pixel points in the candidate blob or an average depth value of a group of pixel points whose distribution is denser than that of other pixel points in the candidate blob.

Furthermore, in the method, the detecting step further includes a step of determining whether a depth value of a pixel is greater than a predetermined minimum threshold value, and determining, in a case where the depth value of the pixel is greater than the predetermined minimum threshold value, that the pixel is a pixel belonging to the candidate blob of the object located within the predetermined distance from the projection surface.

Furthermore, in the method, the detecting step further includes a step of determining whether a pixel belongs to a connected domain, and determining, in a case where the pixel belongs to the connected domain, that the pixel is a pixel belonging to the candidate blob of the object located within the predetermined distance from the projection surface.

According to another aspect of the present invention, a virtual touch panel system is provided. The system comprises a projector configured to project an image on a projection surface; a depth map camera configured to obtain depth information of an environment containing a touch operation area; a depth map processing unit configured to generate an initial depth map based on the depth information obtained by the depth map camera in an initial circumstance, and to determine a position of the touch operation area based on the initial depth map; an object detecting unit configured to detect, from each of plural images continuously obtained by the depth map camera after the initial circumstance, a candidate blob of at least one object located within a predetermined distance from the determined touch operation area; and a tracking unit configured to insert each of the blobs into a corresponding point sequence according to a relationship in time region and space region, of the geometric centers of the blobs detected in adjacent two of the obtained images. The depth map processing unit determines the position of the touch operation area by carrying out processes of detecting and marking connected components in the initial depth map; determining whether the detected and marked connected components include an intersection point of two diagonal lines of the initial depth map; in a case where it is determined that the detected and marked connected components include the intersection point of the diagonal lines of the initial depth map, calculating intersection points between the diagonal lines of the initial depth map and the detected and marked connected components; and linking up the calculated intersection points in order, and determining a convex polygon obtained by linking up the calculated intersection points as the touch operation area. The object detecting unit carries out processes of seeking a depth value of a specific pixel point in the candidate blob of the object; determining whether the depth value is less than a predetermined first distance threshold value, and determining, in a case where the depth value is less than the predetermined first distance threshold value, that the virtual touch panel system is working in a first operational mode; and determining whether the depth value is greater than the predetermined first distance threshold value and less than a predetermined second distance threshold value, and determining, in a case where the depth value is greater than the predetermined first distance threshold value and less than the predetermined second distance threshold value, that the virtual touch panel system is working in a second operational mode. Based on the relationships between the depth value and the predetermined first and second distance threshold values, the virtual touch panel system carries out automatic switching between the first operational mode and the second operational mode.

As a result, by adopting the virtual touch panel system and the interactive mode auto-switching method, it is possible to auto-switch operational modes based on a distance between the hand of a user and a virtual touch panel so that convenience and user-friendliness may be dramatically improved.

### BRIEF DESCRIPTION OF THE DRAWINGS

FIG. 1 illustrates a structure of a virtual touch panel system according to an embodiment of the present invention;

FIG. 2 is an overall flowchart of object detecting as well as object tracking carried out by a control device, according to an embodiment of the present invention;

FIGS. 3A to 3C illustrate an example of how to remove a background depth map from a current depth map;

FIGS. 4A and 4B illustrate two examples of performing binary processing with regard to an input depth map of a current scene so as to obtain blobs (i.e., a point and/or a region) severing as candidate objects;

FIGS. 5A and 5B illustrate two operational modes of a virtual touch panel system according to an embodiment of the present invention;

FIG. 6A illustrates an example of a connected domain used for assigning a number to blobs;

FIG. 6B illustrates an example of a binary image of blobs having a connected domain number, generated based on a depth map;

FIGS. 7A to 7D illustrate an enhancement process carried out with regard to a binary image;

FIG. 8 illustrates an example of detecting the coordinates of the geometric center of the blob shown in FIG. 7D;

FIG. 9 illustrates an example of motion trajectories of the fingers of a user or pointing pens moving on a virtual touch panel;

FIG. 10 is a flowchart of tracking an object;

FIG. 11 is a flowchart of seeking a latest blob of each of existing motion trajectories;

FIG. 12 is a flowchart of seeking a new blob nearest an input existing motion trajectory;

FIG. 13 illustrates a method of performing a smoothing process with regard to a point sequence of a motion trajectory of an object moving on a virtual touch panel, obtained by adopting an embodiment of the present invention;

FIG. 14A illustrates an example of a motion trajectory of an object moving on a virtual touch panel before carrying out a smoothing process, obtained by adopting an embodiment of the present invention;

FIG. 14B illustrates an example of the motion trajectory of the object shown in FIG. 14B, after carrying out the smoothing process; and

FIG. 15 is a block diagram of a control device according to an embodiment of the present invention.

### DETAILED DESCRIPTION OF THE PREFERRED EMBODIMENTS

Hereinafter, various embodiments of the present invention will be concretely described with reference to the drawings. However it should be noted that the same symbols, which are in the specification and the drawings, stand for constructional elements having basically the same function and structure, and repeated explanations for the constructional elements are omitted.

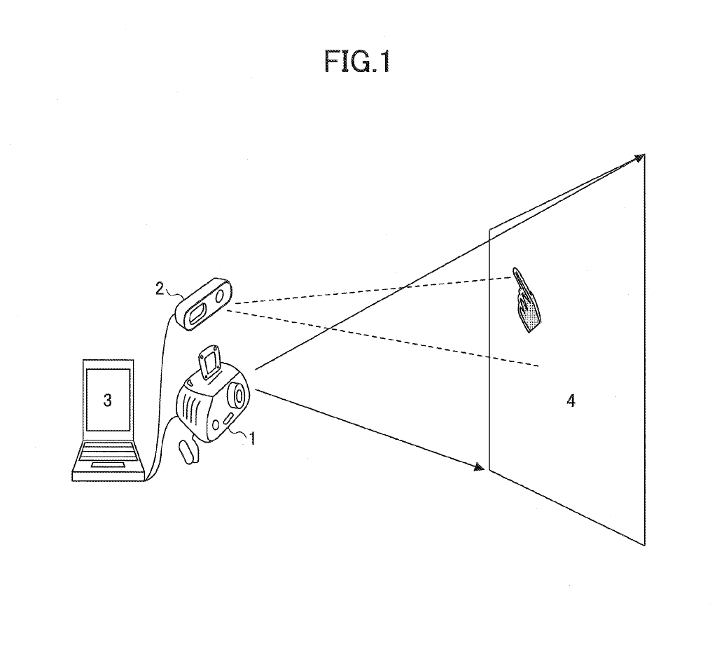

FIG. 1 illustrates a structure of a virtual touch panel system according to an embodiment of the present invention.

As shown in FIG. 1, the virtual touch panel system according to this embodiment includes a projection device 1, an optical device 2, a control device 3, and a projection surface (hereinafter also known as “projection screen” or “virtual screen”) 4. In an embodiment of the present invention, the projection device 1 may be a projector which is used to project an image needing to be displayed on the projection surface 4 to serve as a virtual screen so that a user may execute operations on this virtual screen. The optical device 2 may be, for example, any kind of device able to capture an image; in particular, the optical device 2 may be a depth camera that may obtain depth information of an environment of the projection surface 4, and may generate a depth map based on the depth information. The control device 3 is used to detect at least one object (detection object) within a predetermined distance from the projection surface 4 along a direction far away from the projection surface 4 so as to generate a corresponding smoothed point sequence (motion trajectory). The point sequence is used to carry out a further interactive task, for example, painting on the virtual screen or combining interactive commands.

The projection device 1 projects an image on the projection surface 4 to serve as a virtual screen so that a user may perform an operation, for example, painting or combining interactive commands, on the virtual screen. The optical device 2 captures an environment including the projection surface 4 (the virtual screen) and a detection object (for example, the finger of a user or a pointing pen for carrying out operations on the projection surface 4) located in front of the projection surface 4. The optical device 2 obtains depth information of the environment of the projection surface 4, and generates a depth map based on the depth information. The so-called “depth map” is an image representing distances between a depth camera and respective pixel points in an environment located in front of the depth camera, captured by the depth camera. Each of the distances is recorded by using, for example, a 16-digit number associated with the corresponding pixel point; these 16-digit numbers make up the image. Then the depth map is sent to the control device 3, and the control device 3 detects at least one object within a predetermined distance from the projection surface 4 along a direction far away from the projection surface 4. Once the object is detected, a touch action of the object on the projection surface 4 is tracked so that at least one touch point sequence is generated. After that, the control device 3 performs a smoothing process with regard to the generated touch point sequence so as to achieve a painting function, etc., on this kind of virtual interactive screen. In addition, the touch point sequences may be combined to generate an interactive command so as to achieve an interactive function of the virtual touch panel, and the virtual touch panel may be changed according to the generated interactive command. Here it should be noted that in an embodiment of the present invention, it is also possible to adopt an ordinary camera and an ordinary foreground object detecting system to carry out the above described relevant processing.

In what follows, in order to easily understand a tracking method used in the embodiments of the present invention, a foreground object detecting process is introduced. However, it should be noted that this object detecting process is not an essential means to achieve multiple-object tracking, and is just a premise of tracking plural objects. In other words, the object detecting process does not belong to object tracking.

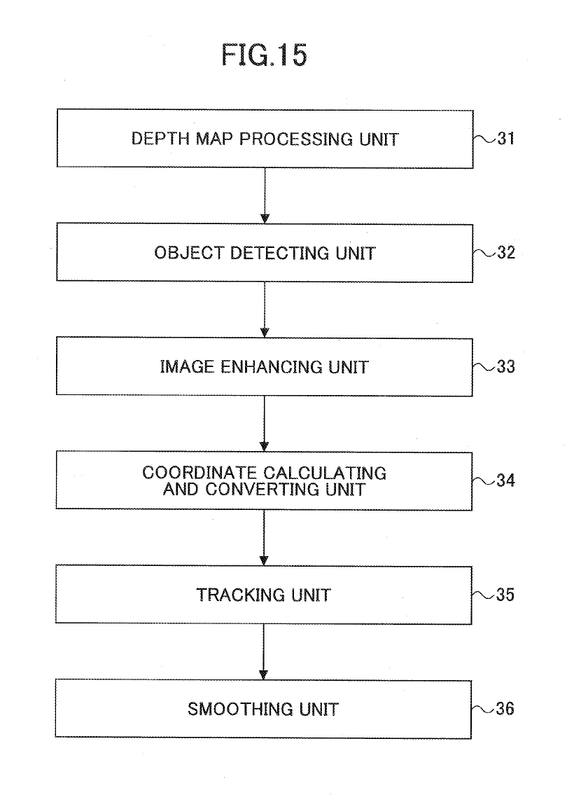

FIG. 15 is a block diagram of a control device according to an embodiment of the present invention.

As shown in FIG. 15, the control device 3 generally contains a depth map processing unit 31, an object detecting unit 32, an image enhancing unit 33, a coordinate calculating and converting unit 34, a tracking unit 35, and a smoothing unit 36. The depth map processing unit 31 processes a depth map received from a depth camera, captured by the depth camera so as to erase background from the depth map, and then assigns numbers to connected domains of the depth map. The object detecting unit 32 determines an operational mode of the virtual touch panel system based on both depth information of the depth map received from the depth map processing unit 31 and two predetermined depth threshold values, and carries out, after determining the operational mode of the virtual touch panel system, binary processing with regard to the depth map based on the depth threshold value corresponding to the determined operational mode to generate a binary image including plural blobs (points and/or regions) serving as candidate objects. After that, the image enhancing unit 33 carries out enhancement with regard to the binary image, and determines a blob serving as the detection object based on a relationship in time region and space region, between the respective candidate blobs and the connected domains as well as the areas of the respective candidate blobs. The coordinate calculating and converting unit 34 calculates the coordinates of the geometric center of the blob serving as the detection object, and converts the coordinates of the geometric center into a target coordinate system, i.e., the coordinate system of the virtual interactive screen. The tracking unit 35 tracks plural blobs detected in plural continuously captured images (depth maps) so as to generate a point sequence by converting the plural geometric centers into the target coordinate system. Then the smoothing unit 36 performs a smoothing process with regard to the generated point sequence.

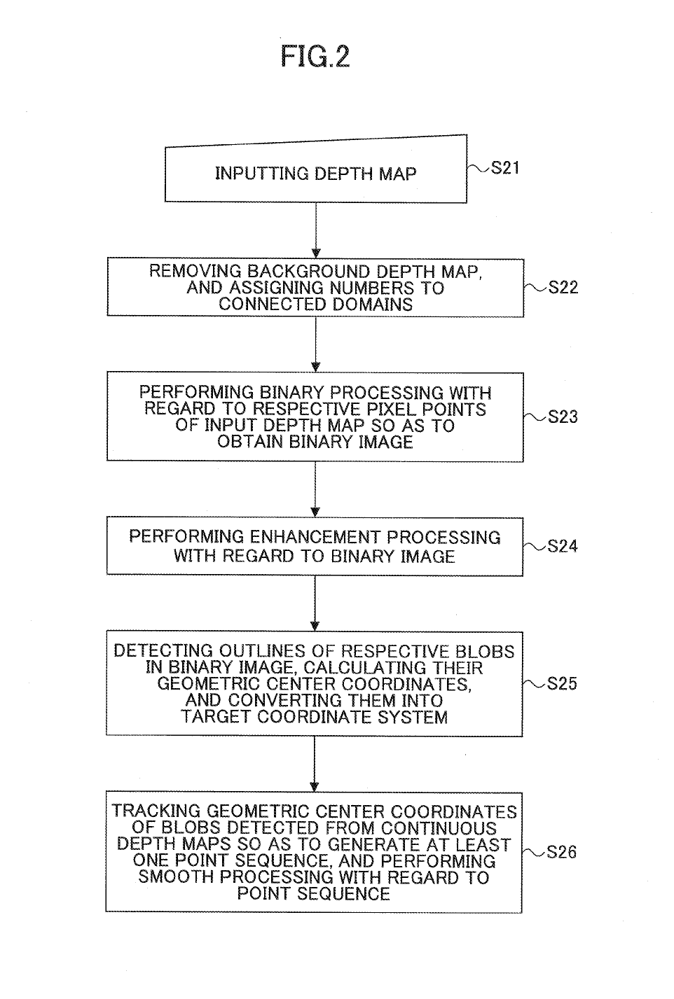

FIG. 2 is an overall flowchart of processing carried out by the control device 3, according to an embodiment of the present invention.

In STEP S21, the depth map processing unit 31 receives a depth map captured by optical device 2 (for example, the depth camera). The depth map is obtained in a manner such that the optical device 2 captures a current environment image, measures, while capturing, distances between respective pixel points and the optical device 2, formed by depth information recorded by using 16-digit numbers (or 8-digit or 32-digit numbers based on actual needs), and renders the 16-digit depth value of each of the pixel points to make up the depth map. For the sake of the follow-on processing step, it is also possible to pre-obtain a background depth map without any object needing to be detected in front of the projection screen.

After that, in STEP S22, the depth map processing unit 31 processes the received depth map so as to remove the background from the depth map, i.e., only retains depth information of the foreground detection object, and then assigns numbers to the retained connected domains in the depth map.

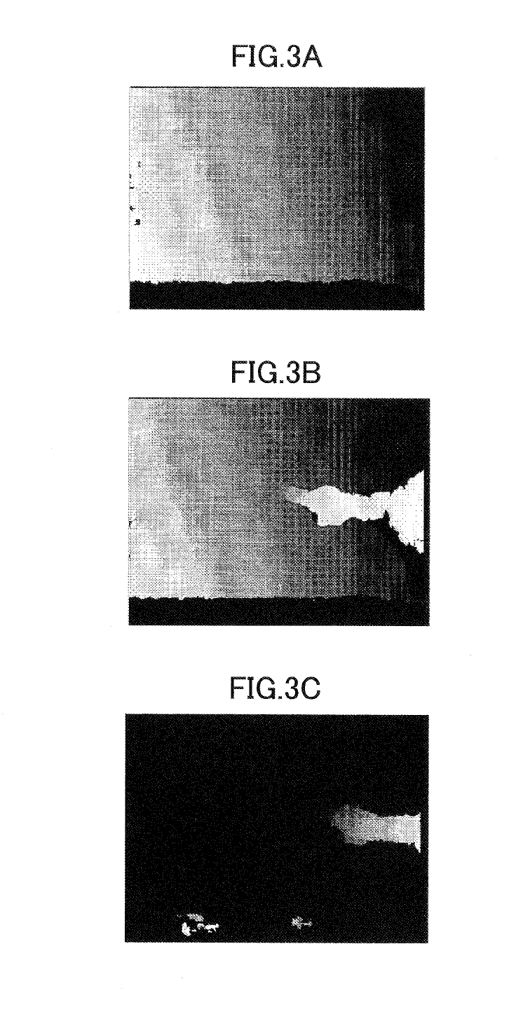

In what follows, STEP S22 of FIG. 2 is concretely described by referring to FIGS. 3A to 3C.

FIGS. 3A to 3C illustrate an example of how to remove a background depth map from a current depth map.

Here it should be noted that the depth maps displayed by adopting 16-digit values are just for description. In other words, the depth maps do not need to be displayed when carrying out the processing.

An instance shown in FIG. 3A is a depth map (background depth map) that only contains background depth information, i.e., a depth map of the projection surface 4 that does not contain any detection object depth maps. An approach of obtaining the background depth map is such that in the initial stage of executing the virtual touch panel function in a virtual touch panel system according to an embodiment of the present invention, the optical device 2 captures a depth map of a current scene, and then stores the instant image of the depth map to serve as the background depth map. When acquiring the background depth map, in the current scene, there is not any object touching the projection surface 4 in front of the projection surface 4 (i.e., between the optical device 2 and the projection surface 4). Another approach of obtaining the background depth map is such that instead of the instant image, a series of continuously captured instant images are utilized to generate a kind of average background depth map.

An instance shown in FIG. 3B is a depth map (current depth map) captured in a current scene. In this current depth map, there is a detection object (for example, a user's finger or a pointing pen) for touching the projection surface 4.

An instance shown in FIG. 3C is a depth map (object depth map) in which the background is removed. A possible approach of removing the background is subtracting the background depth map as shown in FIG. 3A from the current depth map as shown in FIG. 3B. Another possible approach is scanning the current depth map as shown in FIG. 3B and comparing each of the pixel points in the current depth map as shown in FIG. 3B and the corresponding pixel point in the background depth map as shown in FIG. 3A. If the absolute values of the depth difference values of some pixel point pairs are similar and less than a predetermined threshold value, then the corresponding pixel points in the current depth map are removed from the current depth map; otherwise the corresponding pixel points in the current depth map are retained. After that, a number is assigned to at least one connected domain in the object depth map in which the background has been removed.

Here it should be noted that a connected domain mentioned in the embodiments of the present invention is defined as follows. In a case where it is assumed that there are two 3-dimensional (3D) pixel points captured by a depth camera, if projected points of the two 3D pixel points, on the XY plane (the captured image) are adjacent, and the depth difference value of the two 3D pixel points is less than a predetermined threshold value D, then the two 3D pixel points are called “D-connected”. If any two pixel points in a set of 3D pixel points are D-connected, then this set of the 3D pixel points is called “D-connected”. As for a set of D-connected 3D pixel points, if each pixel point P in the set does not have an adjacent point on the XY plane, able to be added into the set under a condition of not breaking the D-connected state, then a domain formed by this set of the D-connected 3D pixel points is called a “maximum D-connected domain”. The connected domain mentioned in the embodiments of the present invention is formed by a set of D-connected 3D pixel points in a depth map, and this set forms a maximum D-connected domain.

In other words, the connected domain in the depth map corresponds to a continuous mass region captured by the depth camera, and is a set of D-connected 3D pixel points in the depth map; this set of the D-connected 3D pixel points makes up a maximum D-connected domain. As a result, assigning a number to a connected domain is such that assigning the same number to each of D-connected 3D pixel points forming the connected domain. That is, pixel points belonging to a same connected domain are assigned a same number. In this way, a matrix of connected domain numbers may be generated. The connected domain of the depth map corresponds to a continuous mass captured by the depth camera.

The matrix of the connected domain numbers is a kind of data structure in which it may be indicated that pixel points in the depth map form a connected domain. Each element in the matrix of the connected domain numbers corresponds to a pixel point in the depth map, and the value of the corresponding element is a number of a connected domain to which the corresponding pixel point belongs (i.e., one connected domain has one number).

Referring to FIG. 2 again; in STEP S23, binary processing is carried out, based on two depth conditions, with regard to each pixel point in the object depth map in which the background has been removed so that plural blobs serving as candidate objects are generated, and a binary image is obtained. Then a connected domain number is assigned to pixel points of the blobs belonging to a same connected domain.

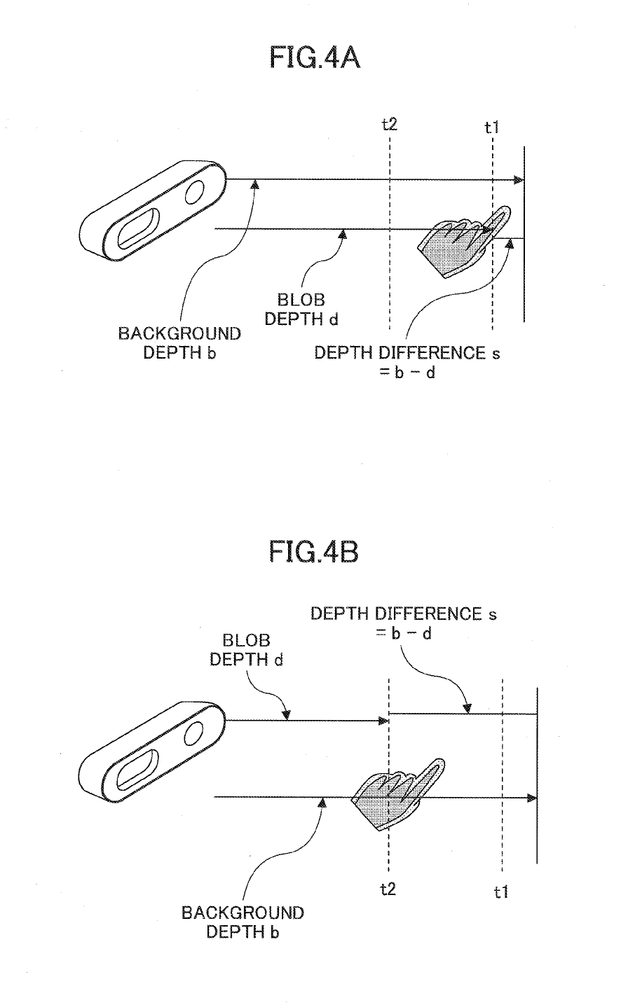

In what follows, STEP S23 of FIG. 2 is concretely illustrated by referring to FIGS. 4A and 4B.

FIGS. 4A and 4B illustrate two examples of carrying out binary processing with regard to an input depth map of a current scene so as to obtain blobs serving as candidate objects.

Here it should be noted that the input depth map of the current scent is the object depth map as shown in FIG. 3C, in which the background has been removed. That is, the input depth map does not contain the background depth information, and may only contain depth information of an object that has been detected.

As shown in FIGS. 4A and 4B, in this embodiment of the present invention, the binary processing is carried out based on relative depth information between each pixel point in the object depth map as shown in FIG. 3C and the corresponding pixel point in the background depth map as shown in FIG. 3A. In this embodiment of the present invention, the depth value of each pixel point of the object depth map is obtained by searching for the corresponding pixel point in the object depth map; the depth value refers to a distance between the depth camera and the object point represented by the corresponding pixel point.

In FIGS. 4A and 4B, the depth value d of each pixel point (object pixel point) of the input object depth map is obtained in a manner of scanning (searching for) the corresponding object pixel point. Then the depth value b of a corresponding pixel point (background pixel point) of the background depth map is acquired in the same manner. After that, a difference value s between the depth value b of each background pixel point and the depth value d of the corresponding object point is calculated, i.e., s=b−d.

In this embodiment of the present invention, it is possible to determine an operational mode of the virtual touch panel system based on an object pixel point having the maximum depth value, in the object depth map. That is, a difference value s between the maximum depth value d of the object pixel point in the object depth map and the depth value b of the corresponding pixel point in the background depth map is calculated.

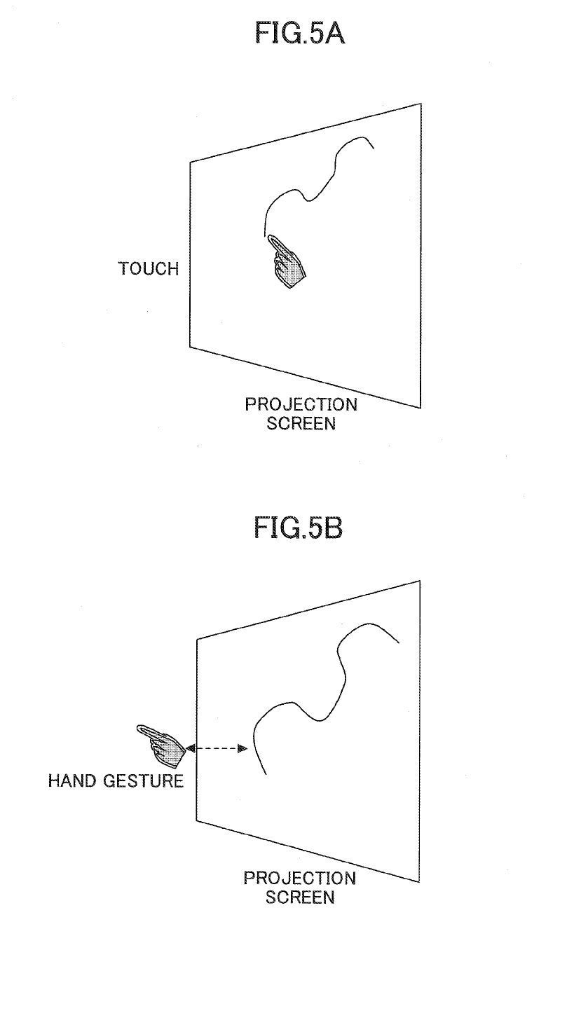

As shown in FIG. 4A, if the calculated difference value s is greater than 0 and less than a first predetermined distance threshold value t1, i.e., 0<s<t1, then it is determined that the virtual touch panel system is working in a touch mode. The touch mode indicates that in this mode, a user is performing a touch operation on a virtual touch panel, as shown in FIG. 5A. Here the first predetermined distance threshold value t1 is also called a “touch distance threshold value”. That is, if the calculated difference value is less than this touch distance threshold value, then the virtual touch panel system works in the touch mode.

In addition, as shown in FIG. 4B, if the calculated difference value s is greater than the first predetermined distance threshold value t1 and less than a second predetermined distance threshold value t2, i.e., t1<s<t2, then it is determined that the virtual touch panel system is working in a hand gesture mode, as shown in FIG. 5B. The hand gesture mode indicates that in this mode, a user's hand does not touch the virtual touch panel, whereas the user carries out a hand gesture operation within a predetermined distance from the virtual touch panel. Here the second predetermined distance threshold value t2 is also called a “hand gesture distance threshold value”.

In this embodiment of the present invention, it is also possible to carry out auto-switching between the two operational modes, i.e., the touch mode and the hand gesture mode. In other words, any one of the two operational modes may be triggered according to a distance between a user's hand and a virtual panel screen as well as the two predetermined distance threshold values.

Here it should be noted that the first and second predetermined distance threshold values t1 and t2 may control accuracy of detecting an object, and are also related to hardware of a depth camera. For example, the first predetermined distance threshold value t1 may be equal to the thickness of a human finger or the diameter of a common pointing pen in general, for example, 0.2-1.5 cm; it is preferred that t1 should be 0.3 cm, 0.4 cm, or 1.0 cm. The second predetermined distance threshold value t2 may be set to, for example, 20 cm (this is a preferable value), i.e., a distance of a user's hand from a virtual touch panel when the user carries out a hand gesture operation in front of the virtual touch panel. Here FIGS. 5A and 5B illustrate the two operational modes of the virtual touch panel system according to this embodiment of the present invention.

Furthermore, in FIGS. 4A and 4B, aside from determining, based on the depth difference values between the object pixel points and the background pixel points, in which operational mode the virtual touch panel system works, the object pixel points themselves also need to satisfy a few conditions that are related to both the depth information corresponding to the object pixel points and a connected domain to which the object pixel points belong.

For example, the object pixel points need to belong to a connected domain. Since the object pixel points are those in the object depth map where the background has been removed, as shown in FIG. 3C, if a pixel point in the input object depth map belongs to a blob serving as a candidate object, then the pixel point should belong to a connected domain defined by the connected domain number matrix. In the meantime, the depth value d of each of the object pixel points should be greater than a minimum distance m, i.e., d>m. The reason is such that when a user carries on an operation in front of the virtual panel screen, no matter in which operation mode the virtual touch panel mode works, the user needs to be located at a position that is near the virtual touch panel, and is far away from the depth camera.

Here it should be noted that by setting the depth value d of each of the object pixel points that is greater than the minimum distance m, it is possible to eliminate interruption caused by other objects accidentally entering the capture range of the depth camera so that the performance of the virtual touch panel system may be improved.

In addition, it should be noted that those people skilled in the art may understand that in the above embodiment, the reason, of adopting the depth value d of the object pixel point having the maximum depth value, in the object depth map to determine the operational mode of the virtual touch panel system, is such that when the user performs an operation, the finger tip of the user is nearest the virtual touch panel in general. As a result, in the above embodiment, the operational mode of the virtual touch panel system is determined actually based on the depth of the pixel point possibly representing the finger tip of the user, i.e., based on the position of the finger tip of the user. However, the embodiments of the present invention are not limited to this.

For example, it is possible to adopt the average value of the depth values of the top N (for example, 5, 10, 20) object pixel points obtained by ranking, in a descending order, the depth value of all the object pixel points in the object depth map, i.e., the average value of the depth values of plural object pixel points having relatively big depth values. Alternatively, it is also possible to adopt, according to the distribution of the depth values of the respective pixel points in the object depth map, the average value of the depth values of plural pixel points whose distribution is dense. As a result, in some more complicated cases, for example, in a case where a user uses a hand gesture except one finger tip to carry out an operation (i.e., it is difficult to accurately determine the position of the finger tip), it is possible to ensure that the detected main candidate object satisfies the above mentioned conditions defined by the two distance threshold values so that the accuracy of determining the operational mode of the virtual touch panel system may be improved. Of course, those people skilled in the art may also understand that as long as the adopted depth values of specific pixel points in the object depth map may function to distinguish between the two operational modes, i.e., the touch mode and the hand gesture mode, they are okay.

After determining the operational mode of the virtual touch panel system, in any one of the touch mode and the hand gesture mode, it is possible to perform the binary processing with regard to the object pixel points in the object depth map according to whether the depth values d of the object pixel points in the object depth map and the depth values b of the corresponding background pixel points in the background depth map satisfy one of the two predetermined distance threshold value conditions, whether the object pixel points belong to a connected domain, and whether the depth values d of the object pixel points are greater than a minimum distance, as described above.

For example, in the touch mode, for each of the object pixel points in the object depth map, if the difference value s between the depth value d of the corresponding object pixel point and the depth value b of the corresponding background pixel point b is less than the first predetermined distance threshold value t1, the corresponding object pixel point belongs to a connected domain, and the depth value d of the corresponding object pixel point is greater than the minimum distance m, then the grayscale value of the corresponding object pixel point is set to 255; otherwise the corresponding object pixel point is set to 0.

Again, for example, in the hand gesture mode, for each of the object pixel points in the object depth map, if the difference value s between the depth value d of the corresponding object pixel point and the depth value of the corresponding background pixel point b is greater than the first predetermined distance threshold value t1 and less than the second predetermined distance threshold value t2, the corresponding object pixel point belongs to a connected domain, and the depth value d of the corresponding object pixel point is greater than the minimum distance m, then the grayscale value of the corresponding object pixel point is set to 255; otherwise the corresponding object pixel point is set to 0.

Of course, in the above binary processing, the two kinds of grayscale values may also be set to 0 and 1. In other words, any kind of binary processing approach, by which the above two kinds of grayscale values can be distinguished, may be adopted in the embodiment of the present invention.

By executing the above binary processing, it is possible to obtain plural blobs possibly representing the detection object, in the binary image.

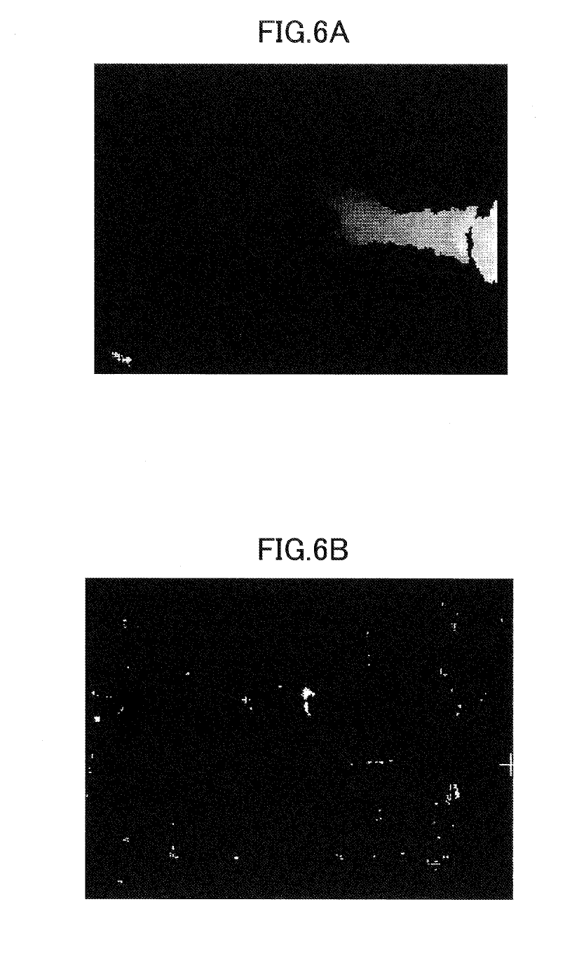

FIG. 6A illustrates an example of a connected domain used for assigning a connected domain number to blobs.

After obtaining the binary image, for example, from the connected domain as shown in FIG. 6A, the pixel points having the connected domain number are obtained, and then the connected domain number is added to the corresponding object pixel points whose grayscale values are, for example 255, in the binary image. In this way, some of the plural blobs in the binary image contain the connected domain number.

Here it should be noted that as described above, the blobs having the connected domain number in the binary image should satisfy the following two conditions: (1) the blobs have to belong to a connected domain; and (2) the difference value s between the depth value d of each of the pixel points in the blobs and the depth value b of the corresponding background pixel point has to satisfy one of the above two distance threshold value conditions, i.e., s=b−d<t1 in the touch mode or t1<s=b−d<t2 in the hand gesture mode.

FIG. 6B illustrates an example of a binary image of blobs having a connected domain number, generated based on a depth map.

As shown in FIG. 6B, the plural blobs (white regions or points) in this figure represent candidate objects of the detection object touching the projection surface 4. In other words, by executing STEP S23 of FIG. 2, it is possible to obtain plural blobs possibly representing the detection object, as shown in FIG. 6B. In addition, it should be noted that some of the plural blobs contain the connected domain number, but others do not.

Here, referring to FIG. 2 again; in STEP S24, enhancement processing is carried out with regard to the binary image obtained after STEP S23 so as to delete noise (i.e. some blobs) not necessary in the binary image, and to render the shape of the remaining blobs in the binary image clearer and more stable. This step is executed by the image enhancing unit 33. In particular, the enhancement processing is carried out by the following steps.

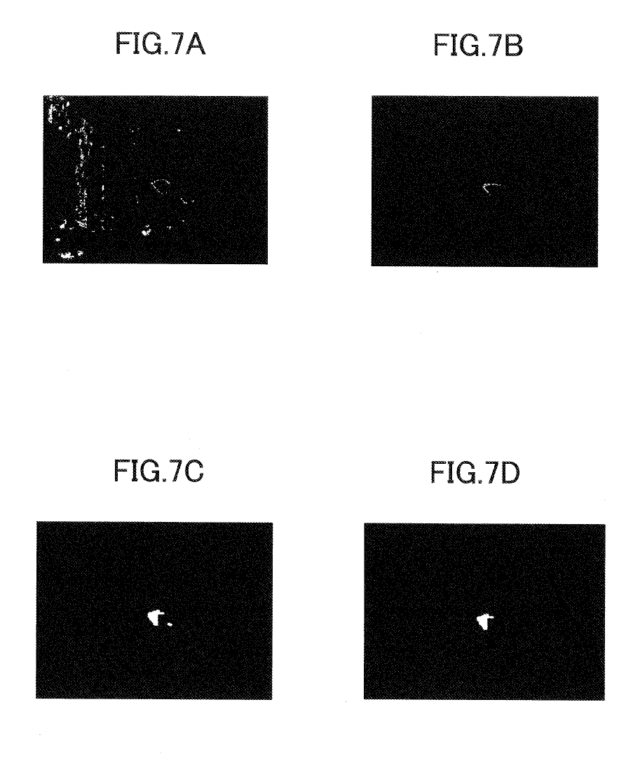

FIGS. 7A to 7D illustrate an enhancement process carried out with regard to a binary image of blobs.

First the blobs not belonging to a connected domain are removed, i.e., the grayscale values of the pixel points in the blobs, to which the connected domain number was not added in STEP S23 of FIG. 2, are changed, for example, from 255 to 0 (or from 1 to 0 in another embodiment of the present invention). In this way, a binary image is obtained as shown in FIG. 7A.

Then the blobs, belonging to a connected domain whose area is less than a predetermined area threshold value Ts, are removed. In the embodiments of the present invention, a blob belonging to a connected domain means that at least one pixel point of this blob located in the connected domain. If the area S of the connected domain to which the blob belongs is less than the predetermined area threshold value Ts, then the corresponding blob is considered noise, and then is removed from the binary image as shown in FIG. 7A; otherwise the corresponding blob is considered a candidate object of the detection object. The predetermined area threshold value Ts may be adjusted according to needs of the virtual touch panel system. In this embodiment, the predetermined area threshold value Ts is the area of 200 pixel points. In this way, a binary image is obtained as shown in FIG. 7B.

Next a few morphology operations are performed with regard to the blobs in the obtained binary image as shown in FIG. 7B. In this embodiment, the dilation operation and the close operation are adopted. That is, the dilation operation is executed one time, and then the close operation is executed iteratively. The number of times that the close operation is executed is a predetermined one that may be adjusted according to needs of the virtual touch panel system. In this embodiment, the number of times is, for example, 6. In this way, a binary image is obtained as shown in FIG. 7C.

Finally, if there are plural blobs belonging to a same connected domain, i.e., if plural blobs have a same connected domain number in the binary image as shown in FIG. 7C, then one of the plural blobs, having the maximum area is retained, and the others are removed. In the embodiments of the present invention, a connected domain may contain plural blobs in which only the blob having the maximum area is considered the detection object, and the others are noise needing to be removed. In this way, a binary image is obtained as shown in FIG. 7D. Here it should be noted that in the binary image of FIG. 7D, there is only one retained blob.

Referring to FIG. 2 again; in STEP S25, the outline of the obtained blob (for example, as shown in the binary image of FIG. 7D) is detected, then the coordinates of the geometric center of the blob is calculated, and then the coordinates of the geometric center is converted into target coordinates. This step is concretely described as follows.

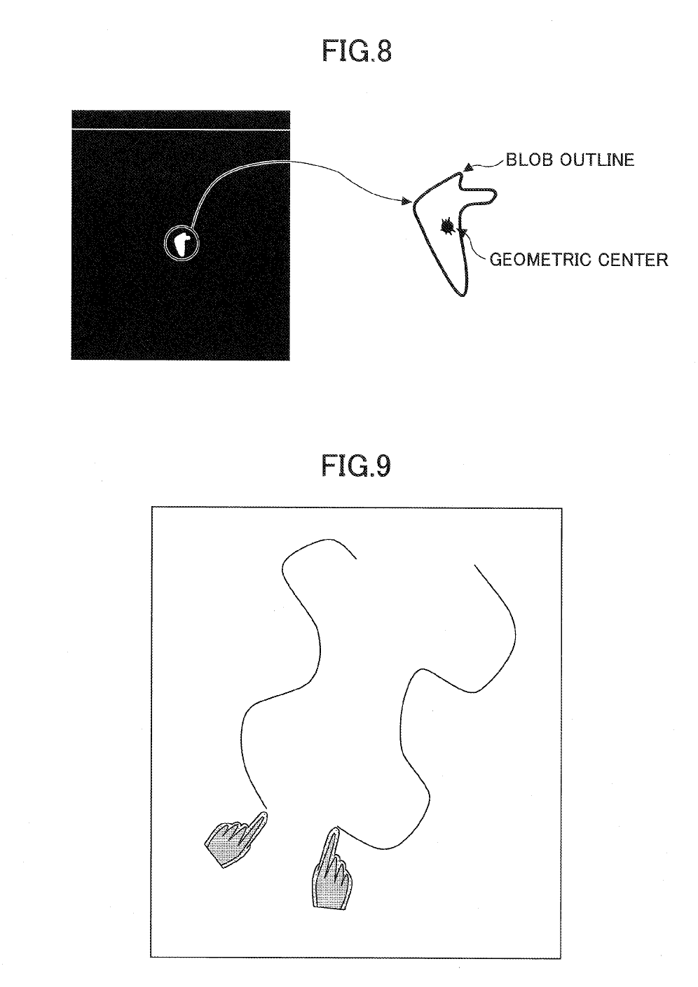

FIG. 8 illustrates an example of detecting the coordinates of the geometric center of the blob in the binary image as shown in FIG. 7D.

As shown in FIG. 8, the coordinated of the geometric center of the blob is calculated according to the geometric information of the blob. The calculation process includes a step of detecting the outline of the blob, a step of calculating the Hu moment of the outline, and a step of calculating the coordinates of the geometric center by using the Hu moment.

In the embodiments of the present invention, it is possible to utilize various well known approaches to detect the outline of the blob. It is also possible to employ various well known approaches to calculate the Hu moment. After the Hu moment is obtained, it is possible to use the following equation (1) to calculate the coordinates of the geometric center of the blob.

(x₀,y₀)=(m₁₀/m₀₀,m₀₁/m₀₀) (1)

Here (x₀, y₀) refers to the coordinates of the geometric center of the blob, and m₁₀, m₀₁, and m₀₀ refer to the Hu moments.

Coordinate conversion is converting the coordinates of the geometric center of the blob from the coordinate system of the binary image as shown in FIG. 7D into the coordinate system of the user interface. The conversion between the coordinate systems may adopt various well known approaches.

In order to acquire a continuous motion trajectory of a detection object, it is possible to utilize touch points of the detection object, detected in depth maps continuously captured in the virtual touch panel system according to the embodiments of the present invention so as to track the blobs of the detected touch points to generate a point sequence. In this way, the motion trajectory of the detection object may be acquired.

In particular, for each of the continuously captured depth maps, after STEPS S21-S25 of FIG. 2 are executed with regard to the corresponding depth map, in STEP S26 of FIG. 2, the coordinates of the geometric center of the blob in the corresponding depth maps is obtained (tracked). In this way, a geometric center point sequence (i.e. the motion trajectory) is generated. Then a smoothing process is carried out to the generated geometric center point sequence. Here the tracking operation and the smoothing operation are performed by the tracking unit 35 and smoothing unit 36, respectively.

FIG. 9 illustrates an example of motion trajectories of a user's fingers or pointing pens moving on a virtual touch panel.

As shown in FIG. 9, the motion trajectories are of two objects (for example, the user's fingers). However, it should be noted that this is only an instance. In other words, there may be, for example, 3, 4, or 5, motion trajectories according to actual needs.

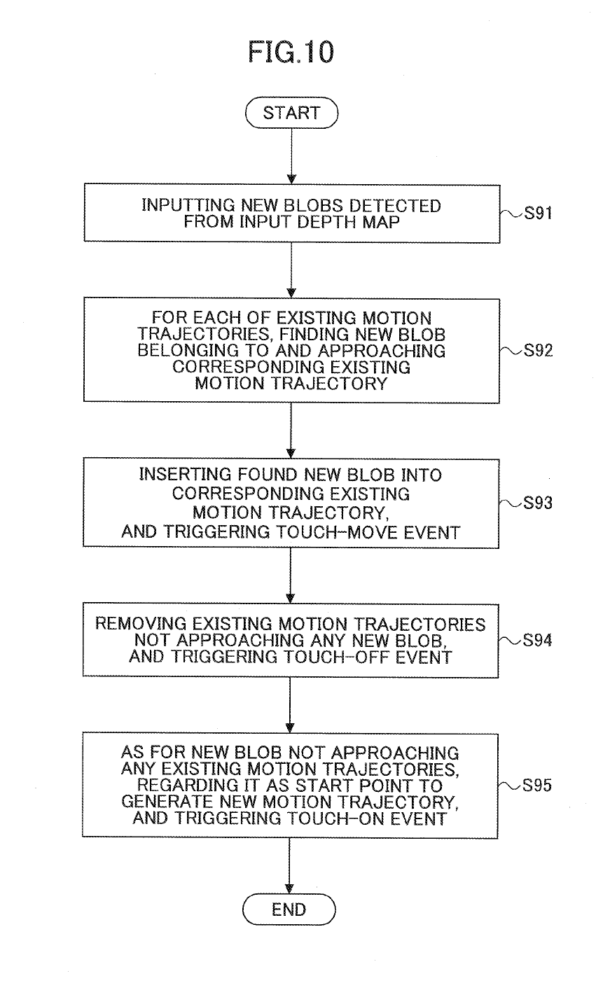

FIG. 10 is a flowchart of tracking an object (detection object).

By repeatedly executing the tracking process as shown in FIG. 10, it is possible to finally obtain a motion trajectory of the detection object in front of the virtual screen. In particular, performing the tracking operation refers to inserting the coordinates in the user interface coordinate system, of the geometric center of a blob in a newly detected depth map into a motion trajectory obtained before.

Based on the coordinates in the user interface coordinate system, of the geometric centers of plural blobs that has been detected, plural newly detected blobs are tracked so that plural motion trajectories are generated, and touch events related to these motion trajectories are triggered. In general, in order to track blobs, it is necessary to carry out classification with regard to the blobs, and then, for each of the classes, to insert the coordinates of the geometric centers of the blobs belonging to the corresponding class into a corresponding point sequence. That is, only the points belonging to a same point sequence may make up a motion trajectory.

For example, as shown in FIG. 9, if the virtual touch panel system supports a painting function, then the points in the two point sequences (i.e. the two motion trajectories) represent painting commands on the projection screen. As a result, the points in the same point sequence may be linked up to form a curve as shown in FIG. 9.

In the embodiments of the present invention, there are three events related to touch, able to be tracked; they are a touch-on event, a touch-move, and a touch-off (also called “touch-up”) event. The touch-on event indicates that an object (detection object) needing to be detected starts to touch the projection screen to form a motion trajectory. The touch-move event indicates that the detection object is touching the projection screen, and the motion trajectory is being generated on the projection screen. The touch-off event indicates that the detection object leaves the projection screen, and the generation of the motion trajectory ends.

As shown in FIG. 10, in STEP 391, the coordinates in the user interface coordinate system, of the geometric centers of new blobs detected by STEPS S21-S25 of FIG. 2, in a depth map are input. In other words, the input is output by the coordinate calculating and converting unit 34.

In STEP S92, based on each of all point sequences obtained after the tracking process was carried out with regard to various depth maps before (i.e., based on all known motion trajectories; hereinafter called “existing motion trajectories”), a new blob approaching the corresponding existing motion trajectory is calculated. In general, all motion trajectories of the detection objects on the touch panel (the projection panel) are stored in the virtual touch panel system. Each of the motion trajectories keeps a tracked blob that is the latest blob inserted into the corresponding motion trajectory. In the embodiments of the present invention, the distance between the new blob and the corresponding existing motion trajectory refers to a distance between the new blob and the latest blob in the corresponding existing motion trajectory.

Then, in STEP S93, the new blob is inserted into the corresponding existing motion trajectory (i.e., the existing motion trajectory approaching the new blob), and a touch-move event corresponding to this existing motion trajectory is triggered.

Next, in STEP S94, for each of the existing motion trajectories, if there is not any new blob approaching the corresponding existing motion trajectory, in other words, if all of the new blobs have been respectively inserted into the other existing motion trajectories, then the corresponding existing motion trajectory is deleted, and a touch-off event corresponding to this existing motion trajectory is triggered.

Finally, in STEP S95, for each of the new blobs, if there is not any motion trajectory approaching the corresponding new blob, in other words, if all of the existing motion trajectories obtained before were deleted due to their corresponding touch-off events, or if a distance between the corresponding new blob and each of the existing motion trajectories is not within a predetermined distance range (for example, greater than a predetermined distance threshold value), then the corresponding new blob is determined as a start point of a new motion trajectory, and a touch-on event corresponding to this new motion trajectory is triggered.

The above STEPS S91-S95 are repeatedly executed so as to achieve tracking with regard to the coordinates in the user interface coordinate system, of the geometric centers of the blobs in the continuous depth maps. In this way, all the points belonging to the same point sequence make up a motion trajectory.

In addition, in a case where there are plural existing motion trajectories, STEP S92 is repeatedly executed with regard to each of the plural existing motion trajectories.

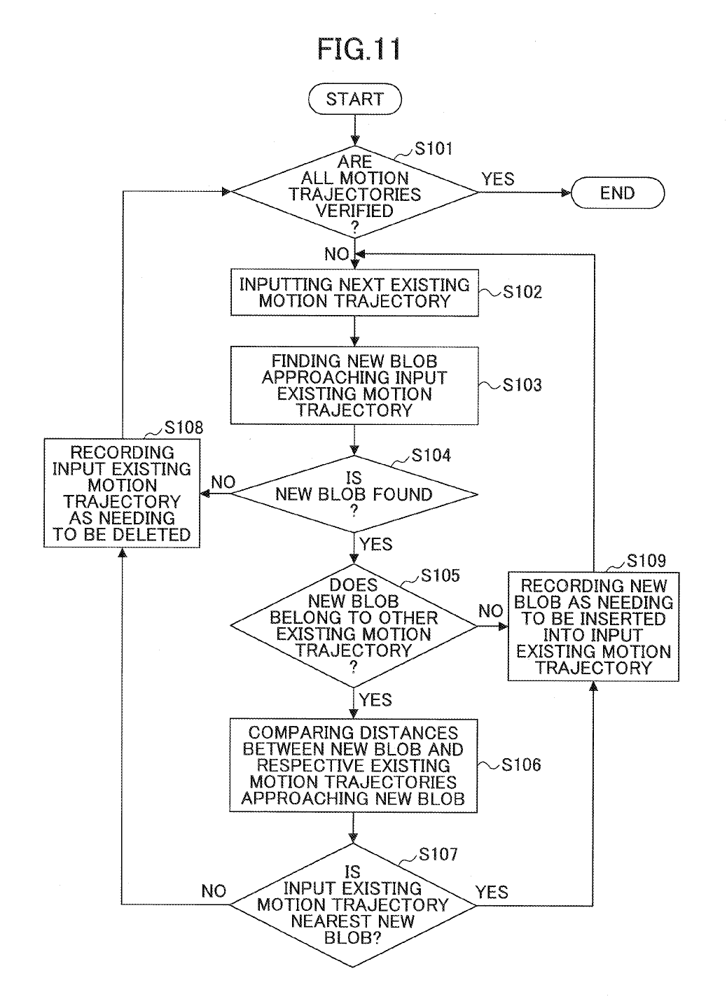

FIG. 11 is a flowchart of seeking a latest blob of each of all existing motion trajectories, i.e., a flowchart of processing when the tracking unit 35 executes STEP S92 of FIG. 10.

In STEP S101, it is determined whether all existing motion trajectories have been scanned (verified). This operation may be achieved by using a simple counter. If STEP 592 of FIG. 10 has been executed with regard to each of the existing motion trajectories, then STEP S92 ends; otherwise the processing goes to STEP S102.

In STEP S102, the next existing motion trajectory is input.

In STEP S103, a new blob approaching the input existing motion trajectory is sought. Then the processing goes to STEP S104.

In STEP S104, it is determined whether the new blob approaching the input existing motion trajectory has been found. If the new blob is found, then the processing goes to STEP S105; otherwise the processing goes to STEP S108.

In STEP S108, since the new blob approaching the input existing motion trajectory does not exist, the input existing motion trajectory is recorded as “needing to be deleted”. Then the processing goes back to STEP S101. Here it should be noted that in STEP S94 of FIG. 10, the existing motion trajectory recorded as “needing to be deleted” triggers the touch-off event.

In STEP S105, it is determined whether the new blob approaching the existing motion trajectory is also approaching the other existing motion trajectories, i.e., whether the new blob is approaching two or more than two existing motion trajectories at the same time. If it is determined that the new blob is approaching two or more than two existing motion trajectories at the same time, then the processing goes to STEP S106; otherwise the processing goes to STEP S109.

In STEP S109, since the new blob is only approaching the input existing motion trajectory, the new blob is inserted into the input existing motion trajectory to serve as the latest blob, i.e., becomes one point of the point sequence of the input existing motion trajectory. Then the processing goes back to STEP S102.

In STEP S106, since the new blob is approaching two or more than two existing motion trajectories, a distance between the new blob and each of the existing motion trajectories is calculated.

Then, in STEP S107, the distances calculated in STEP 5106 are compared so as to determine whether the distance between the new blob and the input existing motion trajectory is the minimum one in the calculated distances, i.e., whether the distance between the new blob and the input existing motion trajectory is less than the other distances. If the distance between the new blob and the input existing motion trajectory is determined as the minimum one, then the processing goes to STEP S109; otherwise the processing goes to STEP S108.

The above STEPS S101-S109 are repeatedly executed so as to achieve the processing carried out in STEP S92 of FIG. 10. As a result, all of the existing motion trajectories and the newly detected blobs may be scanned.

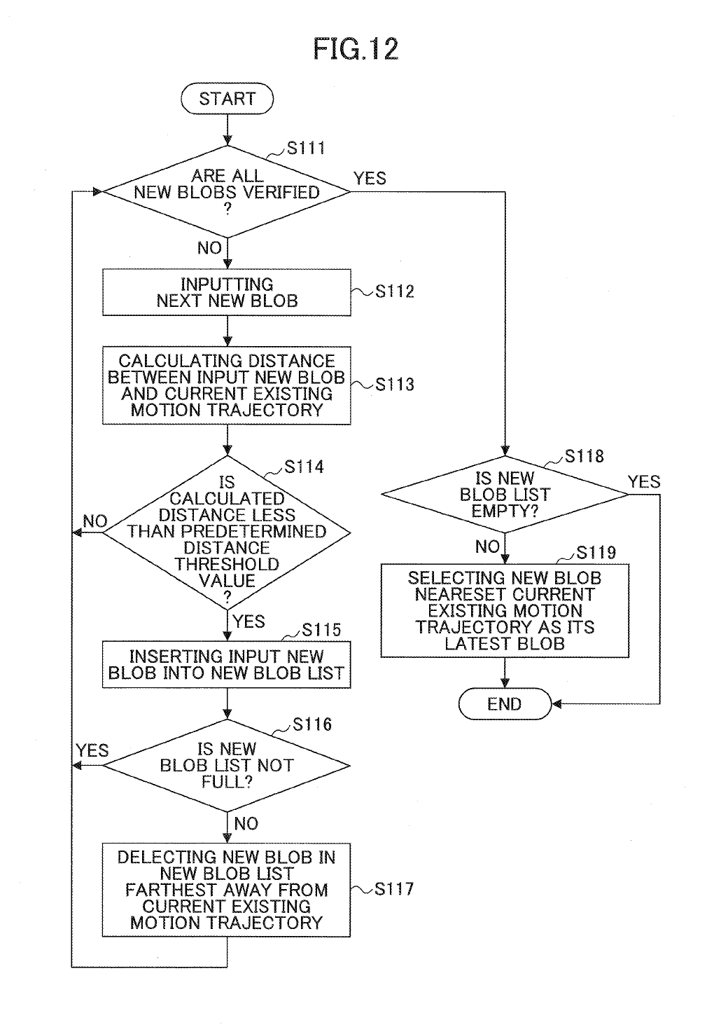

FIG. 12 is a flowchart of seeking a new blob approaching an input existing motion trajectory, i.e., a flowchart of processing when STEP S103 of FIG. 11 is executed.

As shown in FIG. 12, in STEP S111, it is determined whether distances between all input new blobs and the input existing motion trajectory are calculated. If all of the distances are calculated, then the processing goes to STEP S118; otherwise the processing goes to STEP S112.

In STEP S118, it is determined whether a list of the new blobs approaching the input existing motion trajectory is empty. If the list is empty, then the processing ends; otherwise the processing goes to STEP S119.

In STEP S119, a new blob nearest the input existing motion trajectory, in the list of all the new blobs is found. Then the found new blob is inserted into the point sequence of the input existing motion trajectory. After that, STEP S103 of FIG. 11 ends.

In STEP S112, the next new blob is input.

Then, in STEP S113, a distance between the input next new blob and the input existing motion trajectory is calculated.

In STEP S114, it is determined whether the distance calculated in STEP S113 is less than a predetermined distance threshold value Td. If the distance calculated in STEP S113 is determined as less than the predetermined distance threshold value Td, then the processing goes to STEP S115; otherwise the processing goes back to STEP S111. Here it should be noted that the predetermined distance threshold value Td is set to a distance of 10-20 pixel points in general. It is preferred that the predetermined distance threshold value Td should be set to a distance of 15 pixel points. Also the predetermined distance threshold value Td may be adjusted according to needs of the virtual touch panel system. In the embodiments of the present invention, if a distance between a new blob and an existing motion trajectory is less than the predetermined distance threshold value Td, then the new blob is called approaching (or nearest) the existing motion trajectory.

In STEP S115, the next input new blob is inserted into the list of the new blobs approaching the input existing motion trajectory.

Then, in STEP S116, it is determined whether the size of the list of the new blobs approaching the input existing motion trajectory is less than a predetermined size threshold value Tsize. If it is determined that the size of the list is less than the predetermined size threshold value Tsize, then the processing goes back to STEP S111; otherwise the processing goes to STEP S117.

In STEP S117, a new blob in the list, having the maximum distance from the input existing motion trajectory is deleted from the list. Then the processing goes back to STEP S111.

The steps in FIG. 12 are repeatedly performed so as to finish STEP S103 of FIG. 11.

Up to here, FIGS. 10-12 have been utilized to describe the process of tracking the coordinates in the user interface coordinate system, of the geometric centers of the blobs detected in the continuous depth maps. By carrying out the above tracking operation, the touch-on event, the touch-move event, and the touch-off event of at least one detection object may be triggered. As a result, at least one motion trajectory of the detection object on the virtual touch panel may be finally obtained.

However, this kind of motion trajectory on the virtual touch panel is usually not smooth. In other words, it is necessary to carry out a smoothing process with regard to this kind of motion trajectory.

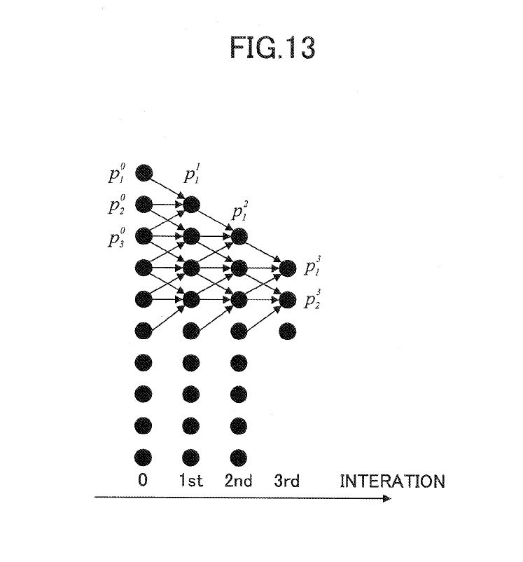

FIG. 13 illustrates a method of performing the smoothing process with regard to a point sequence of a motion trajectory of a detection object moving on a virtual touch panel, obtained by adopting an embodiment of the present invention.

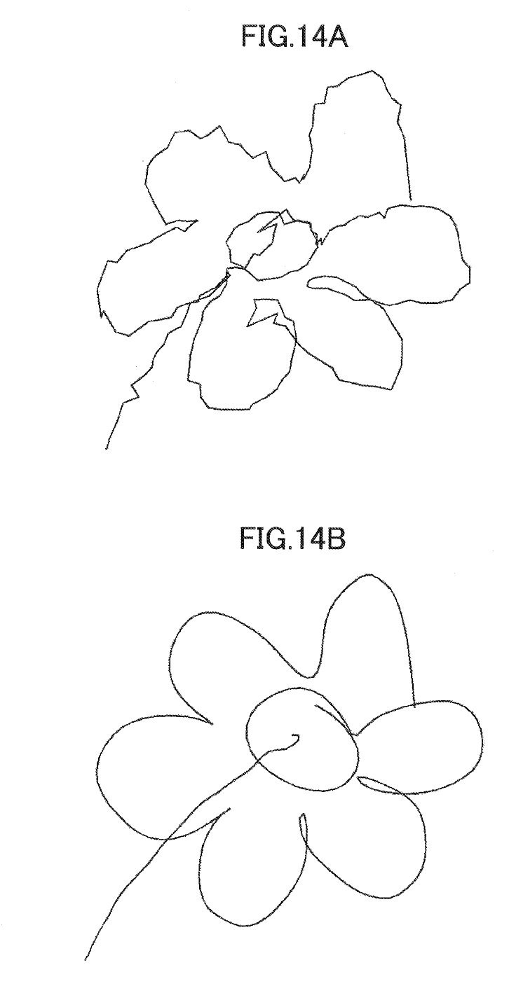

FIG. 14A illustrates an example of a motion trajectory of a detection object moving on a virtual touch panel, before carrying out the smoothing process.

FIG. 14B illustrates an example of the motion trajectory of the detection object shown in FIG. 14A, after carrying out the smoothing process.

In general, the smoothing process of a point sequence refers to carrying out optimization with regard to the coordinates of the points in the point sequence so as to render the point sequence smooth.

As shown in FIG. 13, an original point sequence pₙ⁰ (here n is an integer number) forming a motion trajectory, i.e., an output of the tracking operation serves as an input of the first iteration.

The original point sequence pₙ⁰ is located at the left-most side of FIG. 13.

The following equation (2) is utilized to calculate a point sequence after the next iteration based on the result of this iteration.

$${p}_{n}^{k} = \frac{{\sum }_{j = n}^{n + m - 1} {p}_{j}^{k - 1}}{m} \qquad ( 2 )$$

Here pₙ^{k} refers to a point in the point sequence; k refers to an iteration flag; n refers to a point sequence flag; and m refers to a number parameter.

The iteration is repeatedly calculated until a predetermined iteration threshold value is satisfied. In the embodiments of the present invention, the number parameter m may be 3-7.

In the embodiment shown in FIG. 13, the number parameter in is set to 3. This means that each point in the point sequence after the next iteration is obtained by using three points in the result of this iteration. The predetermined iteration threshold value is 3.

By carrying out the above iteration calculation, it is possible to finally obtain a smooth motion trajectory of a detection object as shown in FIG. 4B.

Furthermore, in the present specification, processing performed by a computer based on a program does not need to be carried out in a time order as shown in the related drawings. That is, the processing performed by a computer based on a program may include some processes carried out in parallel or in series (for example, some parallel processes or some serial processes).

In a similar way, the program may be executed in one computer (processor), or may be executed distributedly by plural computers. In addition, the program may also be executed by a remote computer via a network.

While the present invention is described with reference to the specific embodiments chosen for purpose of illustration, it should be apparent that the present invention is not limited to these embodiments, but numerous modifications could be made thereto by those people skilled in the art without departing from the basic concept and technical scope of the present invention.

The present application is based on Chinese Priority Patent Application No. 201110171845.3 filed on Jun. 24, 2011, the entire contents of which are hereby incorporated by reference.

What is claimed is:

1. A method of auto-switching interactive modes in a virtual touch panel system, comprising:
a step of projecting an image on a projection surface;
a step of continuously obtaining plural images of an environment of the projection surface;
a step of detecting, in each of the obtained images, a candidate blob of at least one object located within a predetermined distance from the projection surface; and
a step of inserting each of the blobs into a corresponding point sequence according to a relationship in time region and space region, of the geometric centers of the blobs detected in adjacent two of the obtained images,
wherein,
the detecting step includes
a step of seeking a depth value of a specific pixel point in the candidate blob of the object;
a step of determining whether the depth value is less than a predetermined first distance threshold value, and determining, in a case where the depth value is less than the predetermined first distance threshold value, that the virtual touch panel system is working in a first operational mode; and
a step of determining whether the depth value is greater than the predetermined first distance threshold value and less than a predetermined second distance threshold value, and determining, in a case where the depth value is greater than the predetermined first distance threshold value and less than the predetermined second distance threshold value, that the virtual touch panel system is working in a second operational mode,
wherein,
based on the relationships between the depth value and the predetermined first and second distance threshold values, the virtual touch panel system carries out automatic switching between the first operational mode and the second operational mode.

2. The method according to claim 1, wherein:
the first operational mode is a touch mode, and in the touch mode, a user performs touch operations on a virtual touch panel; and
the second operational mode is a hand gesture mode, and in the hand gesture mode, the user does not use his hand to touch the virtual touch panel, whereas the user performs hand gesture operations within a certain distance from the virtual touch panel.

3. The method according to claim 1, wherein:
the predetermined first distance threshold value is 1 cm.

4. The method according to claim 1, wherein:
the predetermined second distance threshold value is 20 cm.

5. The method according to claim 1, wherein:
the specific pixel point in the candidate blob of the object is a pixel point whose depth value is maximum in the candidate blob.

6. The method according to claim 1, wherein:
the depth value of the specific pixel point in the candidate blob of the object is a depth value of a pixel point, greater than those of other pixel points in the candidate blob or an average depth value of a group of pixel points whose distribution is denser than that of other pixel points in the candidate blob.

7. The method according to claim 1, wherein:
the detecting step further includes
a step of determining whether a depth value of a pixel is greater than a predetermined minimum threshold value, and determining, in a case where the depth value of the pixel is greater than the predetermined minimum threshold value, that the pixel is a pixel belonging to the candidate blob of the object located within the predetermined distance from the projection surface.

8. The method according to claim 1, wherein:
the detecting step further includes
a step of determining whether a pixel belongs to a connected domain, and determining, in a case where the pixel belongs to the connected domain, that the pixel is a pixel belonging to the candidate blob of the object located within the predetermined distance from the projection surface.

9. A virtual touch panel system comprising:
a projector configured to project an image on a projection surface;
a depth map camera configured to obtain depth information of an environment containing a touch operation area;
a depth map processing unit configured to generate an initial depth map based on the depth information obtained by the depth map camera in an initial circumstance, and to determine a position of the touch operation area based on the initial depth map;
an object detecting unit configured to detect, from each of plural images continuously obtained by the depth map camera after the initial circumstance, a candidate blob of at least one object located within a predetermined distance from the determined touch operation area; and
a tracking unit configured to insert each of the blobs into a corresponding point sequence according to a relationship in time region and space region, of the geometric centers of the blobs detected in adjacent two of the obtained images,
wherein,
the depth map processing unit determines the position of the touch operation area by carrying out processes of
detecting and marking connected components in the initial depth map;
determining whether the detected and marked connected components include an intersection point of two diagonal lines of the initial depth map;
in a case where it is determined that the detected and marked connected components include the intersection point of the diagonal lines of the initial depth map, calculating intersection points between the diagonal lines of the initial depth map and the detected and marked connected components; and
linking up the calculated intersection points in order, and determining a convex polygon obtained by linking up the calculated intersection points as the touch operation area, and
the object detecting unit carries out processes of
seeking a depth value of a specific pixel point in the candidate blob of the object;
determining whether the depth value is less than a predetermined first distance threshold value, and determining, in a case where the depth value is less than the predetermined first distance threshold value, that the virtual touch panel system is working in a first operational mode; and
determining whether the depth value is greater than the predetermined first distance threshold value and less than a predetermined second distance threshold value, and determining, in a case where the depth value is greater than the predetermined first distance threshold value and less than the predetermined second distance threshold value, that the virtual touch panel system is working in a second operational mode,
wherein,
based on the relationships between the depth value and the predetermined first and second distance threshold values, the virtual touch panel system carries out automatic switching between the first operational mode and the second operational mode.
